(19) United States
(12) Patent Application Publication
(10) Pub. No.: US 2025/0220154 A1
(43) Pub. Date: Jul. 3, 2025

(54) LIGHT PROJECTION DEVICE AND DISPLAY DEVICE

(71) Applicant: SONY GROUP CORPORATION, Tokyo (JP)

(72) Inventors: Masahiro TAKADA, Tokyo (JP); Masanori IWASAKI, Tokyo (JP)

(73) Assignee: SONY GROUP CORPORATION, Tokyo (JP)

(21) Appl. No.: 18/851,902

(22) PCT Filed: Mar. 2, 2023
(86) PCT No.: PCT/JP2023/007773

§ 371 Date: Sep. 27, 2024

(30) Foreign Application Priority Data
Apr. 19, 2022 (JP) 2022-068942

(51) Int. Cl. H04N 13/398; H04N 13/339; H04N 13/344; H04N 13/383

(52) U.S. Cl. CPC H04N 13/398; H04N 13/339; H04N 13/344; H04N 13/383

(57) ABSTRACT

The purpose of the present invention is to provide a light projection device that can allow image light to enter an eyeball of a user at a wide viewing angle from a desired direction, regardless of the orientation of the eyeball. The light projection device of the present invention includes: an image light generation system that generates image light; and a projection system that projects the image light generated by the image light generation system onto an optical element worn on or embedded in an eyeball of a user, in which the projection system includes a diaphragm that is disposed on an optical path of the image light from the image light generation system and that is variable in at least a diaphragm position.

### TECHNICAL FIELD

The technology according to the present disclosure (hereinafter also referred to as the “present technology”) relates to a light projection device and a display device.

### BACKGROUND ART

Conventionally, a light projection device that projects image light generated by a display element onto the user's eyeball via an optical system is known.

Some conventional light projection devices respond to the rotation of the user's eyeball.

These light projection devices can allow image light to enter the user's eyeball regardless of the orientation of the eyeball.

For example, Patent Document 1 discloses a light projection device that adjusts an optical axis of an optical system by controlling rotation of a reflective optical member of the optical system in synchronization with eye movement.

For example, Patent Document 2 discloses a light projection device in which an optical system includes two shutter units that face each other and that have openings variable in positions, the optical system performing control such that a straight line connecting the openings of the two shutter units is oriented in a direction of the pupil center of the eyeball.

### CITATION LIST

### Patent Document

Patent Document 1: Japanese Patent Application Laid-Open No. 2014-104174
Patent Document 2: Japanese Patent Application Laid-Open No. 11-196351

### SUMMARY OF THE INVENTION

### Problems to be Solved by the Invention

The light projection device disclosed in Patent Document 1 has room for improvement in allowing image light to enter the eyeball from a desired direction. The light projection device disclosed in Patent Document 2 has room for improvement in allowing image light to enter the eyeball at a wide viewing angle.

In view of this, a main object of the present technology is to provide a light projection device capable of allowing image light to enter a user's eyeball from a desired direction at a wide viewing angle, regardless of the orientation of the eyeball.

### Solutions to Problems

The present technology provides a light projection device including: an image light generation system that generates image light; and a projection system that projects the image light generated by the image light generation system onto an optical element worn on or embedded in an eyeball of a user, in which the projection system includes a diaphragm that is disposed on an optical path of the image light from the image light generation system and that is variable in at least a diaphragm position.

The diaphragm includes a plurality of pixels switchable between an on state for guiding a light beam included in the image light from the image light generation system to an optical path to the optical element and an off state for not guiding the light beam.

The projection system may include a first optical system that guides the image light from the image light generation system to the diaphragm and a second optical system that guides the image light through the diaphragm to the optical element.

The image light generation system may include a display element, the display element may be disposed near a front focal position of the first optical system, and the diaphragm may be disposed near a rear focal position of the first optical system.

The projection system may form an intermediate image of the image light between the second optical system and the optical element.

The diaphragm may be disposed near a front focal position of the second optical system, and the intermediate image may be formed near a rear focal position of the second optical system.

The intermediate image may be formed near a front focal position of the optical element.

The projection system may include: an eyeball information detecting unit that detects eyeball information that is information regarding the eyeball; and a control unit that controls the diaphragm on the basis of a detection result from the eyeball information detecting unit.

The control unit may adjust at least one of the diaphragm position of the diaphragm, a diaphragm size of the diaphragm, or transmittance or reflectance of the diaphragm on the basis of the detection result from the eyeball information detecting unit.

Each of the first and second optical systems may include an optical component having positive refractive power equivalent to refractive power of a convex lens or a plurality of optical components having positive refractive power in total equivalent to refractive power of a convex lens.

The light projection device may be disposed at a position outside a front visual field of the user.

The pixels may be of a transmissive type.

The pixels may be of a reflective type.

The diaphragm may include a pixel array having a plurality of the pixels that is one-dimensionally arranged or two-dimensionally arranged.

The pixel array may be a liquid crystal element.

The pixel array may be a digital mirror device.

The optical element may be a diffractive optical element.

The optical element may be a holographic optical element.

The light projection device may be of a head-mounted type.

The present technology also provides a display device including:
the light projection device; and
the optical element.

### BRIEF DESCRIPTION OF DRAWINGS

FIG. 1 is a diagram illustrating a basic configuration example of a 4f optical system.

FIG. 2A is a diagram illustrating a 4f optical system having no HOE in an imaging optical system. FIG. 2B is a diagram illustrating a 4f optical system having a HOE in an imaging optical system.

FIG. 3 is a diagram for describing a concept of the light projection device according to the present technology.

FIGS. 4A and 4B are diagrams illustrating first and second modes of an optical simulation device that simulates the light projection device according to the present technology.

FIG. 5 is a diagram illustrating a light projection device according to a first embodiment of the present technology.

FIG. 6 is a diagram illustrating an imaging relationship between a display element and a display image in the light projection device according to the first embodiment of the present technology.

FIGS. 7A and 7B are diagrams for describing the relationship between the display element and a diaphragm in the light projection device according to the first embodiment of the present technology.

FIG. 8A is a diagram illustrating principal rays when an eyeball faces front. FIG. 8B is a diagram illustrating principal rays when an eyeball faces diagonally.

FIG. 9A is a diagram illustrating principal rays when an eyeball faces diagonally.

FIG. 9B is a diagram illustrating peripheral rays when an eyeball faces diagonally.

FIG. 10 is a diagram illustrating a display device according to a second embodiment of the present technology.

FIG. 11 is a diagram illustrating a rotation angle of an eyeball.

FIG. 12 is a diagram (diagram of principal rays) illustrating a display device according to a third embodiment of the present technology.

FIG. 13 is a diagram (diagram of peripheral rays) illustrating the display device according to the third embodiment of the present technology.

FIG. 14 is a diagram illustrating a first mode of a display device according to a fourth embodiment of the present technology.

FIG. 15 is a diagram illustrating a second mode of the display device according to the fourth embodiment of the present technology.

### MODE FOR CARRYING OUT THE INVENTION

Hereinafter, preferred embodiments of the present technology will be described in detail with reference to the accompanying drawings. Note that, in the present specification and the drawings, components having substantially the same functional configurations are denoted by the same reference signs, and redundant descriptions are omitted. The embodiments to be described below provide representative embodiments of the present technology, and the scope of the present technology is not to be narrowly construed according to those embodiments. Even in a case where the present specification indicates that each of a light projection device and a display device according to the present technology exhibits a plurality of effects, each of the light projection device and the display device according to the present technology is only required to exhibit at least one effect. The effects described herein are merely examples and are not limited, and other effects may be provided.

Furthermore, the description will be given in the following order.
0. Introduction
1. Light Projection Device According to First Embodiment of Present Technology
2. Display Device According to Second Embodiment of Present Technology
3. Display Device According to Third Embodiment of Present Technology
4. Display Device According to Fourth Embodiment of Present Technology
5. Application of Light Projection Device According to Present Technology
6. Modification of Present Technology

### 0. Introduction

Conventionally, there is known an eye tracking device (for example, see Patent Document 1) that adjusts a position of an eye box (optimum viewing position of a projection image) of a head mounted display (HMD) and an incident angle of a light beam on the eye box depending on a case where the eye box is narrow, an eyeball rotation, or the like. This eye tracking device generally uses a dynamic mechanism that can change a reflection angle of a light beam. However, such a dynamic mechanism needs a space at the time of initial alignment and driving, leading to an increase size, and further needs feedback of a response speed and an adjustment state.

Furthermore, the conventional eye tracking device has room for improvement regarding allowing image light to enter the eyeball from a desired direction due to the structure of changing the reflection angle of a light beam.

On the other hand, there has been proposed a light projection device in which two liquid crystal panels are arranged to face each other, and a transmission portion in each liquid crystal panel is moved according to rotation of an eyeball (for example, see Patent Document 2). However, in this light projection device, image light of a narrow viewing angle transmitted through the transmission portions of the two liquid crystal panels is incident on the eyeball. That is, the light projection device has room for improvement in allowing image light to enter the eyeball at a wide viewing angle.

In view of this, the inventors have conducted intensive studies and developed the light projection device according to the present technology as a light projection device capable of allowing image light to enter a user's eyeball from a desired direction at a wide viewing angle, regardless of the orientation of the eyeball.

### (Basic Configuration of 4f Optical System)

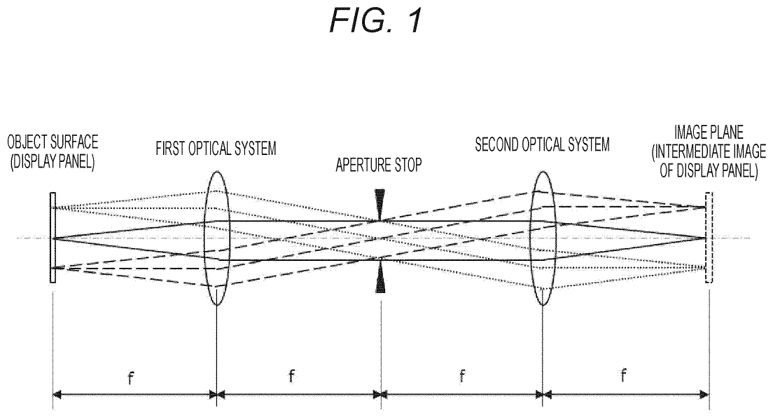

FIG. 1 is a diagram illustrating a basic configuration of a 4f optical system. The 4f optical system includes a first optical system, an aperture stop, and a second optical system. A display panel (object surface) is disposed near the front focal position of the first optical system. The position of the aperture stop substantially coincides with the rear focal position of the first optical system and the front focal position of the second optical system. An intermediate image (image plane) of the display panel is formed near the rear focal position of the second optical system. Note that, if the 4f optical system does not have an aperture stop, the contrast decreases, which makes it difficult to see a display image on the display panel.

### (Necessity of HOE)

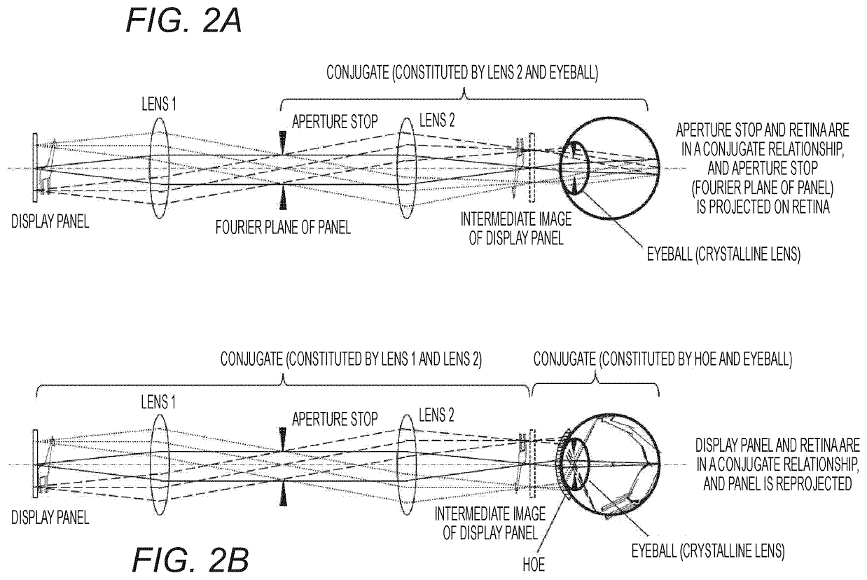

FIG. 2A is a diagram illustrating a 4f optical system having no HOE in an imaging optical system. FIG. 2B is a diagram illustrating a 4f optical system having a HOE in an imaging optical system.

In the 4f optical system illustrated in FIG. 2A, image light generated by a display panel enters the retina through a lens 1, an aperture stop, a lens 2, and an eyeball (crystalline lens) in this order. At this time, an intermediate image of the display panel is formed between the lens 2 and the eyeball. In the 4f optical system, the display panel and the intermediate image are in a conjugate relationship, but since the aperture stop and the retina are in a conjugate relationship (since the intermediate image and the retina are not in a conjugate relationship), the aperture stop (Fourier plane of the panel) is projected on the retina. That is, the display panel is not projected on the retina.

In the 4f optical system illustrated in FIG. 2B, image light generated by a micro organic light emitting diode (MOLED) panel (display panel) enters the retina through the lens 1, the aperture stop, the lens 2, the HOE, and the eyeball (crystalline lens) in this order. At this time, an intermediate image of the MOLED is formed between the lens 2 and the eyeball. In the 4f optical system, the display panel and the intermediate image are in a conjugate relationship, and the intermediate image and the retina are in a conjugate relationship, that is, the display panel and the retina are in a conjugate relationship, so that the display panel is projected on the retina. Note that, in the 4f optical system, when the numerical aperture NA of the aperture stop is reduced, a focus-free state is obtained.

As can be seen from the above description, in order to project the display panel on the retina, an optical element such as HOE is needed, for example, near the eyeball in addition to the 4f optical system.

### (Concept of Light Projection Device According to Present Technology)

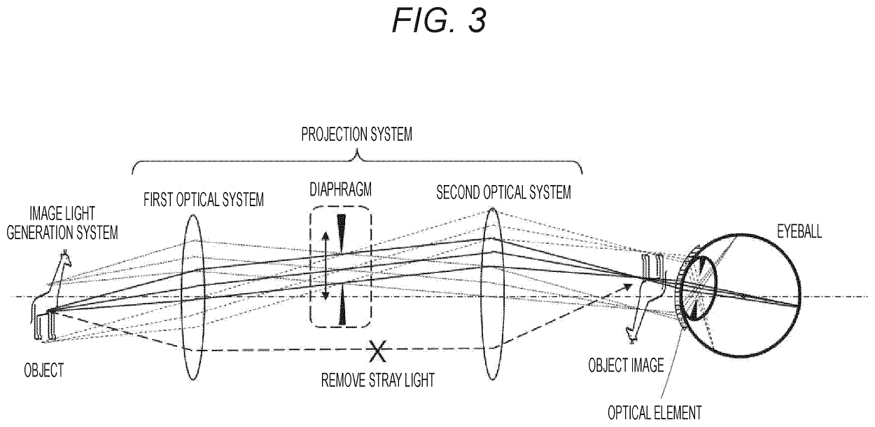

FIG. 3 is a diagram for describing a concept of the light projection device according to the present technology. The light projection device according to the present technology includes: an image light generation system that generates image light (for example, light for displaying an object in FIG. 3); and a projection system that projects the image light generated by the image light generation system onto an optical element (for example, an optical element such as HOE worn on an eyeball) worn on or embedded in the eyeball of a user. The projection system includes a diaphragm that is disposed along the optical path of the image light from the image light generation system and that is variable in at least a diaphragm position.

The diaphragm may have, for example, a plurality of pixels switchable between an on state (guiding state) for guiding a light beam included in the image light from the image light generation system to an optical path to the optical element and an off state (non-guiding state) for not guiding the light beam. The pixels may be either of a transmissive type or a reflective type. The diaphragm may have a pixel array (for example, a transmissive, reflective, or semi-transmissive liquid crystal element, a digital mirror device, or the like) including a plurality of pixels that is one-dimensionally arranged or two-dimensionally arranged. In a case where the diaphragm has a pixel array, the diaphragm position and the diaphragm size are variable by turning on and off the plurality of pixels.

The diaphragm may be a combination of a mechanical diaphragm that is variable in diaphragm size, such as an iris diaphragm, a rotating diaphragm, or a waterhouse diaphragm, and a moving mechanism that moves the diaphragm one-dimensionally or two-dimensionally. The diaphragm may be a combination of an aperture member (opening member) having an aperture (for example, pinhole) and a moving mechanism that moves the aperture member one-dimensionally or two-dimensionally.

Since the diaphragm position of the diaphragm is variable, it is possible to form a guide portion (for example, a transmission portion or an opening portion) at any position and form a non-guide portion (for example, a light shielding portion) around the guide portion. By controlling the diaphragm position according to the rotation of the eyeball, the guide portion can be formed at a position according to the orientation of the eyeball, and the non-guide portion can be formed around the guide portion. As a result, light for displaying an object is incident on the eyeball from a direction corresponding to the orientation of the eyeball, and an image of the object can be viewed in a satisfactory state, and further, unnecessary stray light can be cut.

The diaphragm may be variable in diaphragm size and transmittance or reflectance of the diaphragm. In a case where, for example, the diaphragm has a pixel array, the diaphragm size and the transmittance or reflectance of the diaphragm can be varied by controlling the pixels. In a case where, for example, the diaphragm is a combination of a mechanical diaphragm and a moving mechanism, an optical filter (for example, a neutral density (ND) filter) that varies in transmittance is provided in the opening portion, by which the transmittance of the diaphragm can be varied in addition to the diaphragm size.

The fact that the diaphragm size and the transmittance or reflectance of the diaphragm are variable is effective in that, in a case where the pupil size changes due to a change in brightness of the surrounding environment, for example, an amount of light incident on the eyeball can be adjusted according to the pupil size.

The projection system includes, as an example, a first optical system that guides the image light from the image light generation system to the diaphragm and a second optical system that guides the image light through the diaphragm to the optical element. The 4f optical system includes the first and second optical systems and the diaphragm.

### (Optical Simulation)

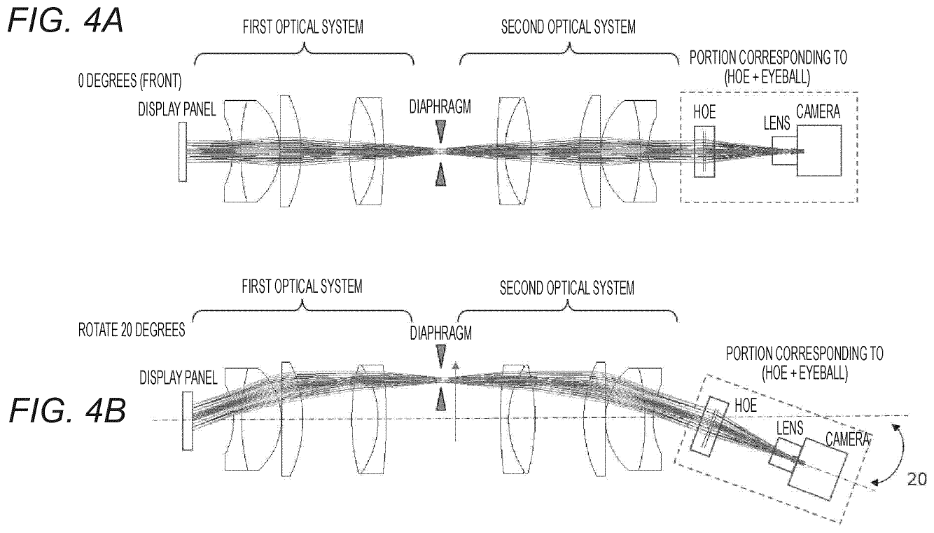

FIGS. 4A and 4B are diagrams illustrating first and second modes of an optical simulation device that simulates the light projection device according to the present technology. This optical simulation device uses a display panel as the image light generation system, and uses a camera (for example, a lens and an image sensor) instead of an eyeball. The HOE is provided integrally with the camera. That is, the HOE and the camera rotate integrally.

In the first mode illustrated in FIG. 4A, the optical axis of the lens of the camera is in the direction of the display panel, and the transmission portion of the diaphragm is formed at a position where a light beam from the display panel is incident at an incident angle of 0°, for example, according to the orientation of the camera. In the second mode illustrated in FIG. 4B, the optical axis of the lens of the camera is oriented in a direction (oblique direction) shifted from the direction of the display panel, and the transmission portion of the diaphragm is formed at a position where a light beam from the display panel is incident at an incident angle of 20°, for example, according to the orientation of the camera. In both the first and second modes, principal rays are incident on the HOE as a parallel light flux. That is, it can be seen from the present simulation that the light projection device according to the present technology can allow the light beam to enter the eyeball from a desired (appropriate) direction regardless of the orientation of the eyeball.

### 1. Light Projection Device According to First Embodiment of Present Technology

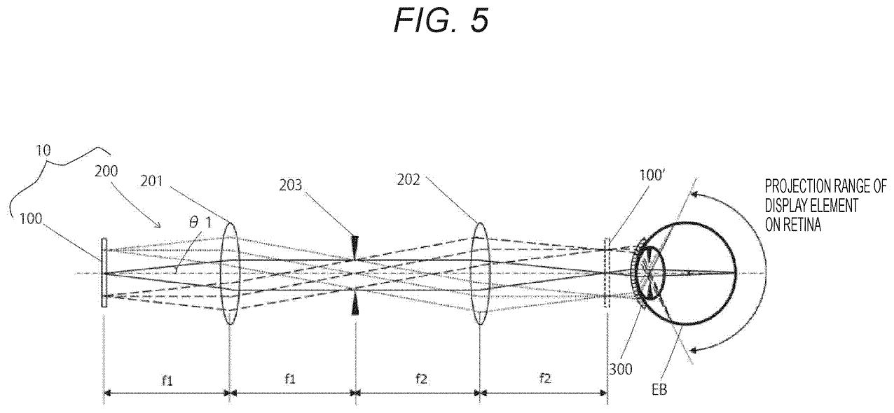

A display device according to a first embodiment of the present technology will be described below with reference to the drawings. FIG. 5 is a diagram illustrating a display device according to the first embodiment of the present technology.

### <<Configuration of Light Projection Device>>

The light projection device 10 is a head-mounted light projection device 10 used in a state of being worn on the head of the user. The light projection device 10 constitutes a display device (HMD) together with an optical element worn on or embedded in the eyeball of the user.

The light projection device 10 includes: an image light generation system 100 that generates image light (light forming an image); and a projection system 200 that projects the image light generated by the image light generation system 100 onto an optical element 300 (hereinafter, also referred to as “eyeball optical element”) worn on an eyeball EB of the user. The image light generation system 100 includes a display element (for example, a display panel). The projection system 200 includes a diaphragm 203 which is disposed on an optical path of the image light from the image light generation system 100 and is variable in at least a diaphragm position.

The diaphragm 203 includes a plurality of pixels switchable between an on state (guiding state) for guiding a light beam included in the image light from the image light generation system 100 to an optical path to the eyeball optical element and an off state (non-guiding state) for not guiding the light beam.

The projection system 200 includes a first optical system 201 that guides the image light from the image light generation system 100 to the diaphragm 203 and a second optical system 202 that guides the image light through the diaphragm 203 to the optical element 300. The first and second optical systems 201 and 202 and the diaphragm 203 constitute a 4f optical system. The focal length of the first optical system 201 is f1. The focal length of the second optical system 202 is f2.

The projection system 200 forms an intermediate image 100′ of the image light between the second optical system 202 and the optical element 300.

The diaphragm 203 is disposed near the front focal position of the second optical system 202, and the intermediate image 100′ is formed near the rear focal position of the second optical system 202 and near the front focal position of the optical element 300.

By means of the optical element 300 and the lens function of the eyeball EB, the intermediate image 100′ is reprojected and formed on the retina. At this time, the numerical aperture NA of the transmission portion of the diaphragm 203 is controlled to be small enough to enable Maxwellian view, by which a so-called focus-free state is obtained, and it is possible to view the image on the display element regardless of the focus adjustment function of the eyeball EB.

Furthermore, by appropriately setting the focal lengths of the first and second optical systems 201 and 202 and the optical element 300, it is also possible to set the apparent angle of view (total angle of view) of the display element projected on the retina to 100° or more.

### (Image Light Generation System)

The display element of the image light generation system 100 is disposed near the front focal position of the first optical system 201. The display element may be, for example, a two-dimensional display element (display panel) used in combination with a light source, such as a liquid crystal panel, or may be, for example, a self-luminous two-dimensional display element (display panel) such as an LED panel. Among self-luminous two-dimensional display elements, a high-definition element capable of controlling a divergence angle, such as a micro organic light emitting diode (MOLED) panel, is particularly preferable. The display element desirably has a divergence angle θ1 (half angle) such that the guide portion (for example, the transmission portion) of the diaphragm 203 has a maximum diameter sufficient for achieving Köhler illumination (telecentric illumination).

### (First and Second Optical Systems)

Each of the first and second optical systems 201 and 202 includes, as an example, an optical component having positive refractive power (power) equivalent to that of a convex lens or a plurality of optical components having positive refractive power in total equivalent to that of a convex lens. That is, the optical component may have positive refractive power equivalent to that of a convex lens alone, or a plurality of the optical components may be combined and may have positive refractive power equivalent to that of a convex lens. Examples of the optical component include a lens (for example, a convex lens), a holographic optical element, a diffractive optical element (DOE), and a concave mirror. The optical component preferably has aberration corrected. As a supplement, the optical component desirably has sufficient imaging performance to form an image on the display element on the retina, and needs aberration correction of about 5.5 LP/deg as a modulation transfer function (MTF) equivalent to eyesight 0.5.

### (Diaphragm)

The diaphragm 203 is disposed near the rear focal position of the first optical system 201, that is, at the position of the Fourier plane of the display element. The diaphragm 203 can move the coordinates at the center of the guide portion (for example, the transmission portion) in a one-dimensional direction or a two-dimensional direction according to the rotation of the eyeball EB. The diaphragm 203 has a non-guide portion (for example, a light shielding portion) around the guide portion.

The pixels of the diaphragm 203 are of a transmissive type as an example. The diaphragm 203 has a pixel array that includes a plurality of pixels arranged one-dimensionally or two-dimensionally. The pixel array is, for example, a liquid crystal element (for example, a liquid crystal panel). As the liquid crystal element, for example, a transmissive guest-host (GH) liquid crystal element or the like is preferable. The GH liquid crystal element has high-speed responsiveness.

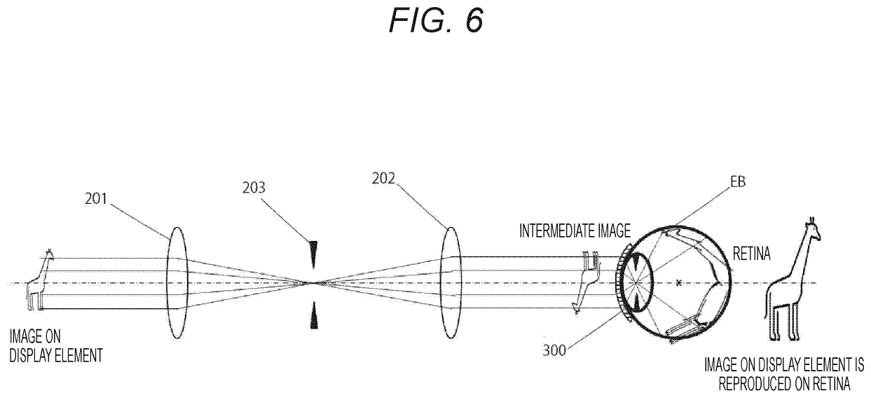

FIG. 6 is a diagram illustrating an imaging relationship between a display element (object) and a display image (image) in the light projection device 10. FIG. 6 illustrates only principal rays in order to provide an image of light beams with a sufficiently small numerical aperture NA. In FIG. 6, the intermediate image is located immediately before the eyeball EB, but since the numerical aperture NA is reduced to such an extent that Maxwellian view is possible, the intermediate image becomes focus-free, and the image displayed on the retina can be recognized.

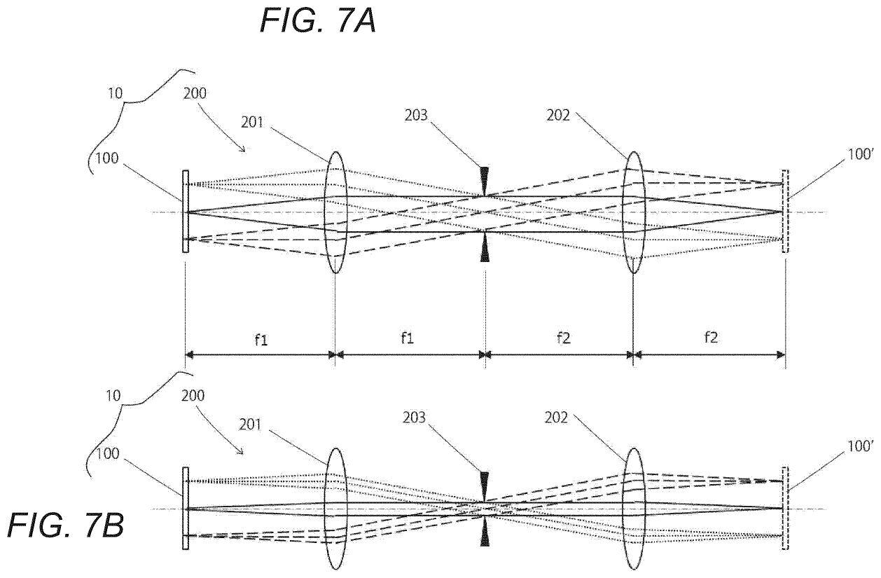

FIGS. 7A and 7B are diagrams for describing the relationship between the display element and the diaphragm 203 in the light projection device 10. FIG. 7A illustrates a case where the size (numerical aperture NA) of the transmission portion of the diaphragm 203 is relatively large. FIG. 7B illustrates a case where the size (numerical aperture NA) of the transmission portion of the diaphragm 203 is relatively small. The image displayed on the display element is formed at the same position as an intermediate image regardless of the size (numerical aperture NA) of the transmission portion of the diaphragm 203. In addition, when the numerical aperture NA decreases (a beam of light becomes thinner), a focus-free state is obtained. Therefore, the tolerance of the arrangement in the optical axis direction between the eyeball optical element (worn on the eyeball, for example) and the eyeball located behind the intermediate image increases, and thus, sufficient performance for practical use is ensured even if there is misalignment in the wearing position of the eyeball optical element.

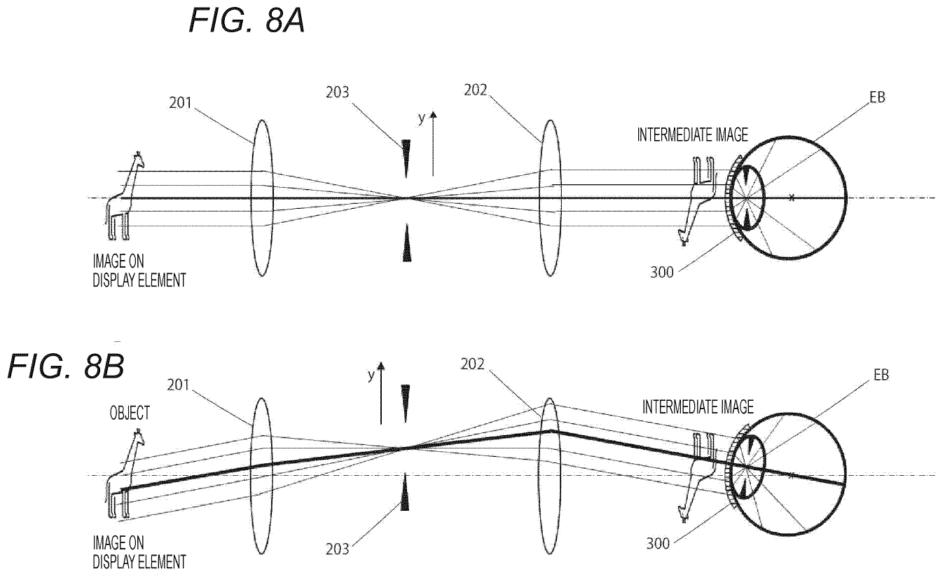

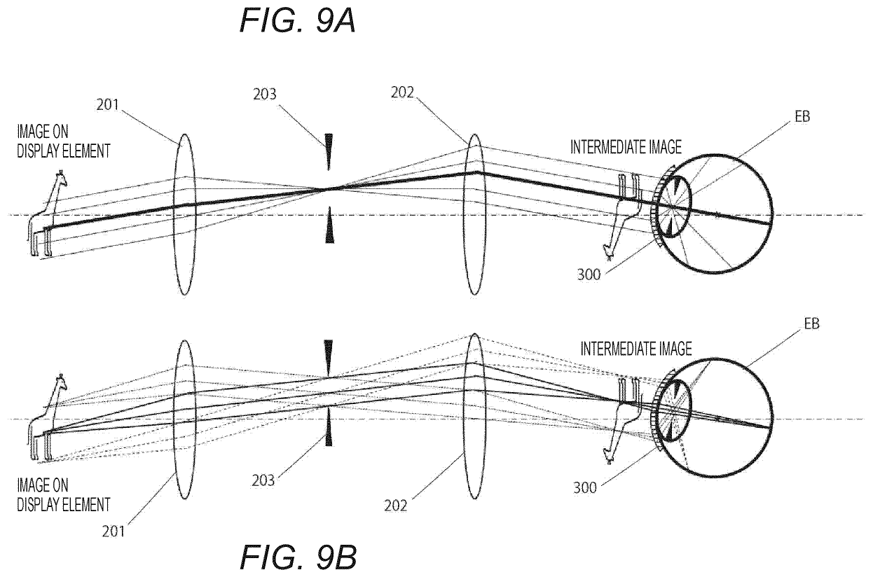

FIG. 8A is a diagram illustrating principal rays when the eyeball faces front (for example, when the user looks directly at the neck of the display image of an animal). FIG. 8B is a diagram illustrating principal rays when the eyeball faces diagonally (for example, when the user looks directly at the abdomen of the display image of the animal). FIG. 9A is a diagram illustrating principal rays when the eyeball faces diagonally (for example, when the user looks directly at the abdomen of the display image of the animal). FIG. 9B is a diagram illustrating peripheral rays when the eyeball faces diagonally (for example, when the user looks directly at the abdomen of the display image of the animal).

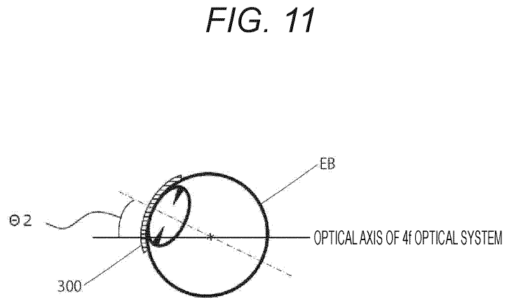

Here, when an axis perpendicular to the optical axis is defined as a y axis in a vertical plane including the optical axis of the 4f optical system of the light projection device 10, the y coordinate at the center of the transmission portion of the diaphragm 203 can be expressed by the following Expression (1) using an eyeball rotation angle θ2 (half angle, see FIG. 11) with respect to the optical axis of the 4f optical system in the vertical plane.

$$y = f 2 \times tan θ2 \qquad ( 1 )$$

When an axis orthogonal to both the optical axis and the y axis of the 4f optical system of the light projection device 10 is defined as an x axis, the x coordinate at the center of the transmission portion of the diaphragm 203 can be expressed by the following Expression (2) using an eyeball rotation angle θ3 (half angle) with respect to the optical axis of the 4f optical system in the horizontal plane.

$$x = f 2 \times tan θ3 \qquad ( 2 )$$

Assuming that the maximum value of the eyeball rotation angle θ2 is θ2ₘₐₓ, the maximum value yₘₐₓ of the y coordinate at the center of the transmission portion can also be determined. In addition, in a case where the numerical aperture NA that enables Maxwellian view is sufficiently small and can be ignored, the approximate divergence angle θ1 (half angle) of the display element can be determined using yₘₐₓ as in the following Expression (3).

$${y}_{max} = f 2 \times tan {θ2}_{max} = f 1 \times tan θ 1 \qquad ( 3 )$$

### (Optical Element)

The optical element 300 (eyeball optical element) is, as an example, a contact lens type optical element to be worn on the eyeball EB of the user. As the optical element 300, for example, a diffractive optical element (DOE), a holographic optical element (HOE), metamaterial, or the like can be used. The optical element 300 refracts the image light from the second optical system 202 and guides the image light to the retina through the pupil of the eyeball EB. As a result, the image displayed by the image light can be overlaid and displayed on the real world.

### <<Effects of Light Projection Device and Display Device>>

The effects of the light projection device 10 according to the first embodiment of the present technology and the display device including the light projection device 10 will be described below.

The light projection device 10 includes an image light generation system 100 that generates image light, and a projection system 200 that projects the image light generated by the image light generation system 100 onto an optical element 300 worn on the eyeball EB of the user. The projection system 200 includes a diaphragm 203 that is disposed on an optical path of the image light from the image light generation system 100 and that is variable in at least a diaphragm position.

The light projection device 10 can allow image light to enter the eyeball of the user from a desired direction at a wide viewing angle, regardless of the orientation of the eyeball.

Even if the light projection device 10 has only one diaphragm 203, the user cannot see an image unless he/she looks in a direction (determined direction) in which the efficiency of the optical element 300 (for example, HOE) is good. Therefore, an image can be displayed with a limited line-of-sight direction without narrowing the angle of view. That is, the optical element 300 functions like a second diaphragm, and the luminance and contrast are improved. This is because the incident angle of the principal ray approaches a design value by moving the diaphragm position according to the rotation of the eyeball EB and the optical element 300, so that the efficiency of the optical element 300 can be maximized.

The light projection device 10 can achieve pan focus, that is, can obtain a focus-free state, by appropriately controlling the diaphragm size of the diaphragm, whereby the display image can be viewed regardless of the eyesight (focus adjustment ability). In addition, by intentionally controlling the focus-free state, it is also possible to control an amount of blur of the contour of the display image, and thus, the image can be naturally overlaid.

In the light projection device 10, the transmittance of the diaphragm 203 is variable. Thus, the display luminance can be adjusted according to an environment (background), whereby the display image can be easily viewed.

The light projection device 10 needs only one diaphragm 203. Therefore, low power consumption and a decrease in size and weight can be achieved. Further, it is not necessary to, for example, control a plurality of diaphragms in synchronization with each other, so that a light projection device more suitable for HMD can be achieved.

The diaphragm 203 includes a plurality of pixels switchable between an on state for guiding a light beam included in the image light from the image light generation system 100 to an optical path to the optical element 300 and an off state for not guiding the light beam. Thus, the diaphragm position can be adjusted at high speed and with high accuracy. In addition, since a mechanical drive unit is unnecessary, downsizing can be achieved, and initialization adjustment when the light projection device is worn is easy.

The projection system 200 includes a first optical system 201 that guides the image light from the image light generation system 100 to the diaphragm 203 and a second optical system 202 that guides the image light through the diaphragm 203 to the optical element 300. As a result, a 4f optical system including the first and second optical systems 201 and 202 and the diaphragm 203 can be configured.

The image light generation system 100 includes a display element, the display element is disposed near the front focal position of the first optical system, and the diaphragm 203 is disposed near the rear focal position of the first optical system 201. With this configuration, the diaphragm 203 is on the Fourier plane of the display element, and thus, the principal ray is not vignetted even when the diaphragm position is changed, and the display range (field of view in which images can be simultaneously displayed) of the display element can be widened.

By setting the directivity of the display element so that the divergence angle is in an appropriate state (divergence angle that covers the entire rotation range of the eyeball), it is not necessary to move a beam of light mechanically (for example, using a gimbal mirror).

It is also possible to adjust a position where the image is overlaid on the external field of view by changing the display position of the display element (the display position within the element size). As a result, the image can be displayed in a direction other than the direct-view direction, whereby the visual field is not disturbed during walking or exercise.

### 2. Image Display Device According to Second Embodiment of Present Technology

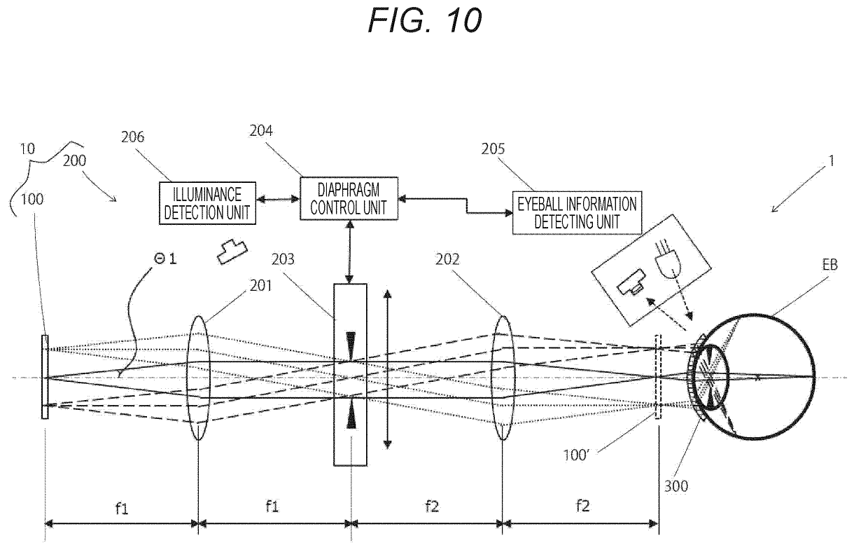

A display device according to a first embodiment of the present technology will be described below with reference to the drawings. FIG. 10 is a diagram illustrating a display device 1 according to the second embodiment of the present technology.

The display device 1 includes a light projection device 10 and an optical element 300. In the display device 1, the projection system 200 includes an eyeball information detecting unit 205 that detects eyeball information (for example, the orientation of the eyeball (line-of-sight), the pupil size, and the like) that is information regarding the eyeball EB, and a diaphragm control unit 204 (control unit) that controls a plurality of pixels on the basis of a detection result from the eyeball information detecting unit 205. The projection system 200 may further include an illuminance detection unit 206.

The eyeball information detecting unit 205 has at least a line-of-sight detecting function of measuring a rotation angle of the eyeball EB. The eyeball information detecting unit 205 may include, for example, an infrared light emitting element (for example, a light emitting diode, a laser, or the like) and an infrared imaging element (for example, CCD, CMOS, and the like). In this case, the eyeball information detecting unit 205 receives infrared light emitted from the infrared light emitting element and reflected by the eyeball EB by the infrared imaging element to thereby detect the Purkinje image formed on the eyeball EB and measure the movement of the visual axis (rotation angle of the eyeball EB). The eyeball information detecting unit 205 may acquire the pupil size and/or an amount of change of the pupil size during the measurement. The eyeball information detecting unit 205 sends information such as the detected rotation angle and pupil size of the eyeball EB to the diaphragm control unit 204.

The illuminance detection unit 206 includes, for example, an illuminance sensor. The illuminance detection unit 206 detects a change in brightness of the surrounding environment (for example, movement from a bright place to a dark place (or vice versa) such as cloudiness, a tunnel, or indoor movement) and transmits information for making the brightness of the display image appropriate to the diaphragm control unit 204.

Note that the illuminance detection unit 206 is not always necessary. In addition, another function of acquiring a change in brightness of the surrounding environment may be used instead. For example, an amount of change in pupil size may be acquired from the detection result of the eyeball information detecting unit 205, and a change in the surrounding environment may be estimated from the acquired amount of change.

The diaphragm control unit 204 controls a plurality of pixels on the basis of a detection result of at least the eyeball information detecting unit 205 among the eyeball information detecting unit 205 and the illuminance detection unit 206 to adjust at least one of a diaphragm position of the diaphragm 203 (position of the transmission portion), a diaphragm size of the diaphragm 203 (size of the transmission portion), or a transmittance of the diaphragm 203 (transmittance of the transmission portion).

Specifically, as an example, the diaphragm control unit 204 can guide only a beam of light from the line-of-sight direction to the eyeball EB by controlling the x and y coordinates of the transmission portion of the diaphragm 203 according to the line-of-sight direction (the orientation of the eyeball) detected by the eyeball information detecting unit 205. Accordingly, a state in which the incident angle of the principal ray reaching the optical element 300 has a value corresponding to the design value is always maintained, and thus, the diffraction efficiency of the optical element 300 is maintained, and a bright and high-contrast image can be viewed. Furthermore, an image can be displayed at a position corresponding to the line-of-sight direction (rotation angle of the eyeball), that is, in a so-called direct-view direction.

The diaphragm control unit 204 can adjust the numerical aperture NA of the transmission portion according to the eyesight (focus adjustment ability) of the user who is a wearer of the light projection device 10 or display contents. Thus, the user can view a focus-free image regardless of the user's eyesight and display contents. In addition, the transmission portion is disposed on the Fourier plane of the display element, and principal rays all pass therethrough regardless of the numerical aperture NA thereof. Therefore, the image on the display element can be entirely projected as an intermediate image without being blocked at the position of the diaphragm 203.

The diaphragm control unit 204 can adjust a light quantity of the beam of light of the image light from the display element by controlling the transmittance of the pixel on the basis of the pupil size, an amount of change in the pupil size, a change in brightness of the surrounding environment, and the like from the eyeball information detecting unit 205. Therefore, the brightness of the display image can be maintained even if the focus-free state is established with the numerical aperture NA being reduced.

Note that, when the display device 1 is used as an HMD, the display device 1 may include, for example, an external information acquiring device such as a camera that captures an image of a surrounding environment. In that case, the diaphragm control unit 204 may provide feedback on information acquired by the external information acquiring device to assist the above-described control.

In addition, an optical functional element that deflects a light beam may be added to an appropriate position in order to downsize the light projection device 10 or to mount the light projection device 10 on the head.

### 3. Display Device According to Third Embodiment of Present Technology

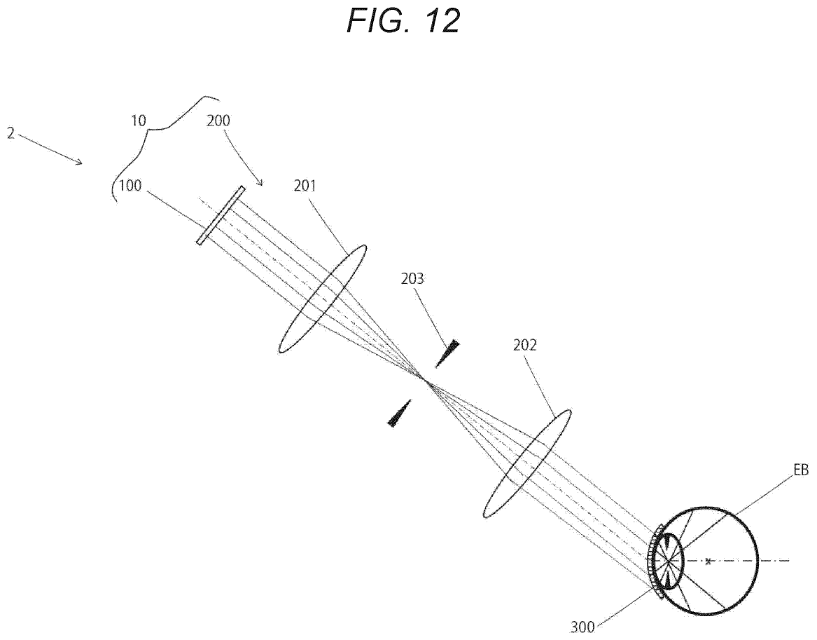

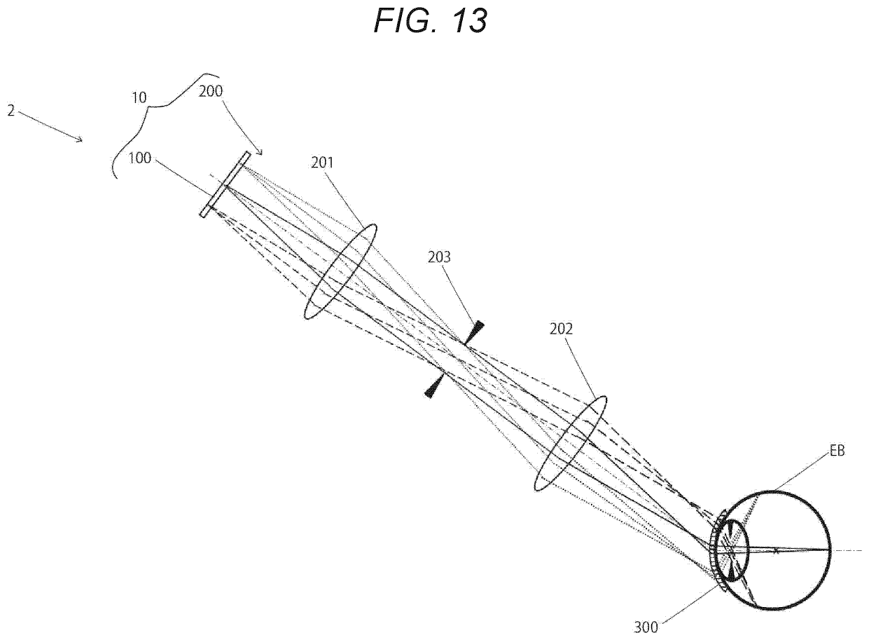

FIG. 12 is a diagram (diagram of principal rays) illustrating a display device 2 according to a third embodiment of the present technology. FIG. 13 is a diagram (diagram of peripheral rays) illustrating the display device 2 according to the third embodiment of the present technology. The display device 2 has a configuration similar to that of the display device 1 according to the second embodiment except that the light projection device 10 is disposed at a position outside the front visual field of the user.

In the display device 2, the light projection device 10 is disposed such that image light is obliquely incident on the optical element 300 at a predetermined angle. That is, the optical axis of the 4f optical system of the light projection device 10 is disposed so as to be inclined with respect to the visual axis (line-of-sight) of the eyeball EB which faces front and on which the optical element 300 is worn. The optical element 300 can deflect a light beam incident at the predetermined angle to any direction. Therefore, even if the light projection device 10 is disposed at a position outside the front visual field of the user, the display image can be appropriately projected on the retina. Such projection is difficult to achieve in a configuration in which two liquid crystal panels are disposed to face each other.

Furthermore, in the display device 2, an optical functional element for bending the optical path may be provided as appropriate in order to downsize the light projection device 10 or to mount the light projection device 10 on the head.

### 4. Image Display Device According to Fourth Embodiment of Present Technology

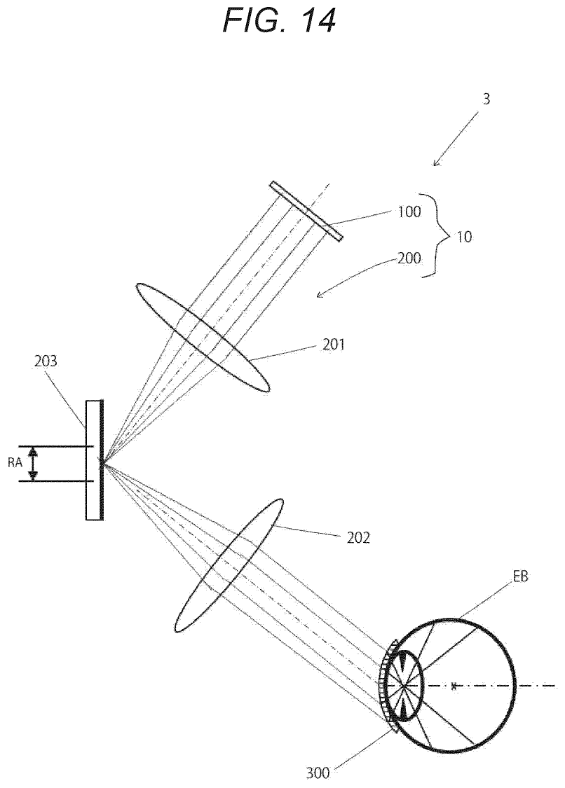

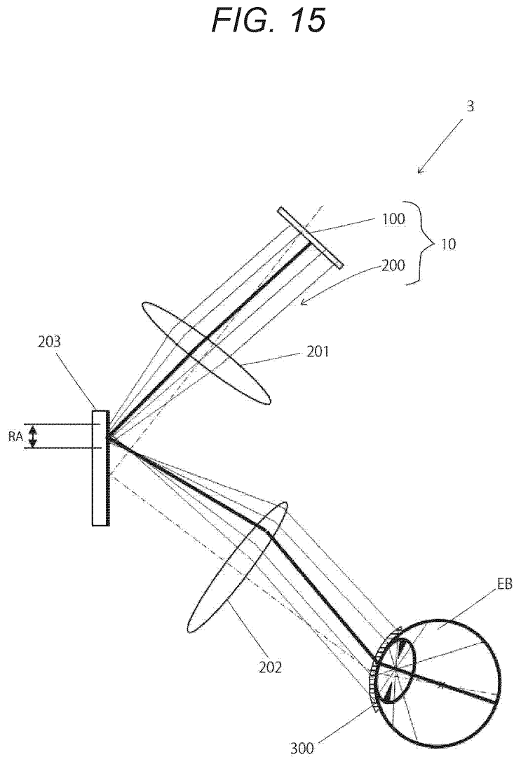

FIG. 14 is a diagram illustrating a first mode (a state in which the eyeball EB faces front) of a display device 3 according to a fourth embodiment of the present technology. FIG. 15 is a diagram illustrating a second mode (a state in which the eyeball EB faces diagonally) of the display device 3 according to the fourth embodiment of the present technology. The display device 3 has a configuration similar to that of the display device 1 according to the second embodiment except that the pixel array of the diaphragm 203 is a digital mirror device (DMD). That is, in the display device 3, the pixels are reflective.

In the display device 3, the digital mirror device included in the diaphragm 203 as a pixel array includes a plurality of micromirrors (pixels) switchable between an on state (guiding state) for guiding a light beam included in image light from the image light generation system 100 to an optical path to the optical element 300 and an off state (non-guiding state) for not guiding the light beam.

More specifically, the pixel array of the diaphragm 203 of the display device 3 includes a plurality of micromirrors (pixels) arranged one-dimensionally or two-dimensionally. The plurality of micromirrors is independently operable. Each of the micromirrors is on/off controlled between a guiding orientation (on state) for guiding the light beam included in the image light to a path to the optical element 300 and a non-guiding orientation (off state) for not guiding the light beam. Each of the micromirrors can be controlled by, for example, a diaphragm control unit 204 (see FIG. 10). By selectively turning on at least one of the plurality of micromirrors, a specific region of the digital mirror device can function as a reflection area RA that reflects an incident light beam toward the path to the optical element 300. In the display device 3, an optical functional element for bending the optical path may be provided as appropriate in order to downsize the light projection device 10 or to mount the light projection device 10 on the head.

### 5. Application of Light Projection Device According to Present Technology

As is apparent from the above description, the light projection device according to the present technology is suitable as a light projection device for HMD. Furthermore, the light projection device according to the present technology can determine the line-of-sight direction in a state where a wide display visual field is ensured, and thus, is also suitable for being mounted on a moving body such as a bicycle, a motorcycle, an automobile, an aircraft, or a ship. In particular, when being mounted on a moving body moving at high speed, the light projection device is effective in that information regarding issuing warnings, navigation, etc. can be provided. The present technology can also provide a moving body on which the light projection device is mounted.

### 6. Modification of Present Technology

The light projection device 10 according to the first embodiment described above and the display devices 1 to 3 according to the second to fourth embodiments described above can be appropriately changed.

In each of the above embodiments, the optical element 300 is a contact lens type to be worn on the eyeball EB, but may be an embedded type to be embedded in the eyeball EB instead of the contact lens type.

For example, the configurations of the light projection device 10 according to the first embodiment and the display devices 1 to 3 according to the second to fourth embodiments may be appropriately combined as long as there is no inconsistency.

Note that the present technology may also have following configurations.

(1) A light projection device including:
an image light generation system that generates image light; and
a projection system that projects the image light generated by the image light generation system onto an optical element worn on or embedded in an eyeball of a user, in which
the projection system includes a diaphragm that is disposed on an optical path of the image light from the image light generation system and that is variable in at least a diaphragm position.

(2) The light projection device according to (1), in which the diaphragm includes a plurality of pixels switchable between an on state for guiding a light beam included in the image light from the image light generation system to an optical path to the optical element and an off state for not guiding the light beam.

(3) The light projection device according to (1) or (2), in which the projection system includes a first optical system that guides the image light from the image light generation system to the diaphragm and a second optical system that guides the image light through the diaphragm to the optical element.

(4) The light projection device according to (3), in which the image light generation system includes a display element, the display element is disposed near a front focal position of the first optical system, and the diaphragm is disposed near a rear focal position of the first optical system.

(5) The light projection device according to (3) or (4), in which the projection system forms an intermediate image of the image light between the second optical system and the optical element.

(6) The light projection device according to (5), in which the diaphragm is disposed near a front focal position of the second optical system, and the intermediate image is formed near a rear focal position of the second optical system.

(7) The light projection device according to (5) or (6), in which the intermediate image is formed near a front focal position of the optical element.

(8) The light projection device according to any one of (1) to (7), in which the projection system includes: an eyeball information detecting unit that detects eyeball information that is information regarding the eyeball; and a control unit that controls the diaphragm on the basis of a detection result from the eyeball information detecting unit.

(9) The light projection device according to (8), in which the control unit adjusts at least one of the diaphragm position of the diaphragm, a diaphragm size of the diaphragm, or transmittance or reflectance of the diaphragm on the basis of the detection result from the eyeball information detecting unit.

(10) The light projection device according to any one of (3) to (9), in which each of the first and second optical systems includes an optical component having positive refractive power equivalent to refractive power of a convex lens or a plurality of optical components having positive refractive power in total equivalent to refractive power of a convex lens.

(11) The light projection device according to any one of (1) to (10), the light projection device being disposed at a position outside a front visual field of the user.

(12) The light projection device according to any one of (2) to (11), in which the pixels are of a transmissive type.

(13) The light projection device according to any one of (2) to (11), in which the pixels are of a reflective type.

(14) The light projection device according to any one of (2) to (13), in which the diaphragm includes a pixel array having a plurality of the pixels that is one-dimensionally arranged or two-dimensionally arranged.

(15) The light projection device according to (14), in which the pixel array is a liquid crystal element.

(16) The light projection device according to (14), in which the pixel array is a digital mirror device.

(17) The light projection device according to any one of (1) to (16), in which the optical element is a diffractive optical element.

(18) The light projection device according to any one of (1) to (17), in which the optical element is a holographic optical element.

(19) The light projection device according to any one of (1) to (18), the light projection device being of a head-mounted type.

(20) A display device including:
the light projection device according to any one of (1) to (19); and
the optical element.

(21) A moving body on which the light projection device according to any one of (1) to (20) is mounted.

### REFERENCE SIGNS LIST

1, 2, 3 Display device
10 Light projection device
100 Image light generation system
100′ Intermediate image
200 Projection system
201 First optical system
202 Second optical system
203 Diaphragm
204 Diaphragm control unit (control unit)
205 Eyeball information detecting unit
300 Optical element
EB Eyeball

What is claimed is:

1. A light projection device, comprising:
an image light generation system that generates image light; and
a projection system that projects the image light generated by the image light generation system onto an optical element worn on or embedded in an eyeball of a user, wherein
the projection system includes a diaphragm that is disposed on an optical path of the image light from the image light generation system and that is variable in at least a diaphragm position.

2. The light projection device according to claim 1, wherein the diaphragm includes a plurality of pixels switchable between an on state for guiding a light beam included in the image light from the image light generation system to an optical path to the optical element and an off state for not guiding the light beam.

3. The light projection device according to claim 1, wherein
the projection system includes
a first optical system that guides the image light from the image light generation system to the diaphragm and
a second optical system that guides the image light through the diaphragm to the optical element.

4. The light projection device according to claim 3, wherein
the image light generation system includes a display element,
the display element is disposed near a front focal position of the first optical system, and
the diaphragm is disposed near a rear focal position of the first optical system.

5. The light projection device according to claim 3, wherein the projection system forms an intermediate image of the image light between the second optical system and the optical element.

6. The light projection device according to claim 5, wherein
the diaphragm is disposed near a front focal position of the second optical system, and
the intermediate image is formed near a rear focal position of the second optical system.

7. The light projection device according to claim 5, wherein the intermediate image is formed near a front focal position of the optical element.

8. The light projection device according to claim 1, wherein
the projection system includes:
an eyeball information detecting unit that detects eyeball information that is information regarding the eyeball; and
a control unit that controls the diaphragm on a basis of a detection result from the eyeball information detecting unit.

9. The light projection device according to claim 8, wherein the control unit adjusts at least one of the diaphragm position of the diaphragm, a diaphragm size of the diaphragm, or transmittance or reflectance of the diaphragm on a basis of the detection result from the eyeball information detecting unit.

10. The light projection device according to claim 3, wherein each of the first and second optical systems includes an optical component having positive refractive power equivalent to refractive power of a convex lens or a plurality of optical components having positive refractive power in total equivalent to refractive power of a convex lens.

11. The light projection device according to claim 1, the light projection device being disposed at a position outside a front visual field of the user.

12. The light projection device according to claim 2, wherein the pixels are of a transmissive type.

13. The light projection device according to claim 2, wherein the pixels are of a reflective type.

14. The light projection device according to claim 2, wherein the diaphragm includes a pixel array having a plurality of the pixels that is one-dimensionally arranged or two-dimensionally arranged.

15. The light projection device according to claim 14, wherein the pixel array is a liquid crystal element.

16. The light projection device according to claim 14, wherein the pixel array is a digital mirror device.

17. The light projection device according to claim 1, wherein the optical element is a diffractive optical element.

18. The light projection device according to claim 1, wherein the optical element is a holographic optical element.

19. The light projection device according to claim 1, the light projection device being of a head-mounted type.

20. A display device, comprising:
the light projection device according to claim 1; and
the optical element.
